(19) United States
(12) Patent Application Publication
(10) Pub. No.: US 2026/0349421 A1
(43) Pub. Date: Nov. 5, 2026

(54) PRODUCTION MANAGEMENT SYSTEM

(71) Applicant: SHIBUYA CORPORATION, Kanazawa-shi (JP)

(72) Inventors: Ryota HASEGAWA, Kanazawa-shi (JP); Hiroki YAKUBO, Kanazawa-shi (JP); Hiroshi UTSUMI, Kanazawa-shi (JP)

(73) Assignee: SHIBUYA CORPORATION, Kanazawa-shi (JP)

(21) Appl. No.: 19/642,493

(22) Filed: Apr. 8, 2026

(30) Foreign Application Priority Data
Apr. 11, 2025 (JP) 2025-065806

(51) Int. Cl. G05B 19/418

(52) U.S. Cl. CPC G05B 19/4189

(57) ABSTRACT

A production management system includes a control unit and a determination unit. The control unit manages operation of a production system in accordance with signals from production apparatuses and sensors provided in transport devices, each sensor detecting a standby state for discharging articles to a downstream production apparatus. When the standby state is detected, the control unit stops a corresponding transport device and stops discharge of the articles from an upstream production apparatus. The determination unit determines a cause of the stoppage of a target apparatus, and identifies a transport device that first stopped on a downstream side of the target apparatus when the target apparatus stops due to stoppage of discharge of the articles from the target apparatus.

### BACKGROUND OF THE INVENTION

### 1. Field of the Invention

The present invention relates to a production management system for a production system in which articles are sequentially processed by a plurality of production apparatuses via a plurality of transport devices.

### 2. Description of the Related Art

Conventionally, in a production system where a product is manufactured by sequentially processing articles by a plurality of production apparatuses, a failure in one production apparatus may cause other production apparatuses to stop. In particular, when a bottleneck apparatus having the lowest processing speed stops, the impact on the line productivity is significant. However, the stoppage of the bottleneck apparatus is not necessarily caused by an error of the production apparatus that first stopped in the entire production system. Therefore, merely analyzing error reports from each production apparatus cannot identify the specific error that caused the stoppage of the bottleneck apparatus. Accordingly, when the bottleneck apparatus stops, operators must conventionally inspect multiple potential causes to identify and resolve the issue, which disadvantageously requires significant time and labor.

To address such problems, systems have been proposed that automatically identify the cause. For example, Patent Document 1 proposes a system including stop cause analyzing means for analyzing the machine that caused the longest-process machine to stop, as well as the reason for the stoppage. Further, Patent Document 2 proposes a system for tracking all error information about the reasons for stoppages in each production apparatus and determining whether this information has propagated to a bottleneck apparatus.

### CITATION LIST

### Patent Literature

[Patent Document 1] JP-A-H05-200657
[Patent Document 2] JP Patent No. 5972222

### SUMMARY OF THE INVENTION

However, in the system of Patent Document 1, since it is necessary to sequentially analyze the operation of each production apparatus by tracing back in time, the analysis takes a long time, and abnormalities in the transport devices connecting the production apparatuses are not taken into consideration. Therefore, when an accumulation apparatus is provided among the production apparatuses, and short-duration stoppages (temporary stops) occur within a range covered by the accumulation apparatus, it becomes difficult to identify the cause of the stoppage. On the other hand, in the system of Patent Document 2, it is necessary to provide dedicated sensors at both the inlet and the outlet of each production apparatus, which makes the corresponding program complicated.

An object of the present invention is to provide a production management system capable of efficiently identifying, with a simplified configuration, an area or equipment that has caused a specific production apparatus to stop in production system in which articles are sequentially processed by a plurality of production apparatuses via a plurality of transport devices.

A production management system according to one aspect of the present invention is a production management system for a production system comprising a plurality of production apparatuses and transport devices sequentially connecting the plurality of production apparatuses, wherein each of the transport devices is provided with a sensor configured to detect a standby state for discharging articles to a downstream production apparatus, the production management system comprising a control unit configured to manage operation of the production system based on signals from the plurality of production apparatuses and the sensors, and a determination unit configured to determine a cause of the stoppage of a target apparatus selected in advance from among the plurality of production apparatuses, wherein the control unit is configured to stop the transport device provided with the sensor and to stop discharge of the articles from an upstream production apparatus to the transport device when the sensor detects the standby state, and wherein the determination unit is configured to identify a transport device that first stopped on a downstream side of the target apparatus when the target apparatus stops due to stoppage of discharge of the articles from the target apparatus.

In some embodiments, the determination unit is configured to determine the cause of the stoppage of the target apparatus based on error information output from the identified transport device or a production apparatus located downstream thereof.

In some embodiments, the determination unit is configured to determine that the cause of the stoppage of the target apparatus exists in an apparatus located upstream of the target apparatus when the target apparatus stops due to a shortage of the articles supplied to the target apparatus.

According to the present invention, in a production system in which articles are sequentially processed by a plurality of production apparatuses via a plurality of transport devices, it is possible to provide a production management system capable of efficiently identifying, with a simplified configuration, an area or equipment that has caused a specific production apparatus to stop.

### BRIEF DESCRIPTION OF THE DRAWINGS

FIG. 1 is a schematic plan view showing an arrangement of a production system to which a production management system according to one embodiment of the present invention is applied.

FIG. 2 is a diagram showing an example of a history of the apparatus identified as the root cause and the corresponding cause when the target filler apparatus stops.

### DESCRIPTION OF THE PREFERRED EMBODIMENTS

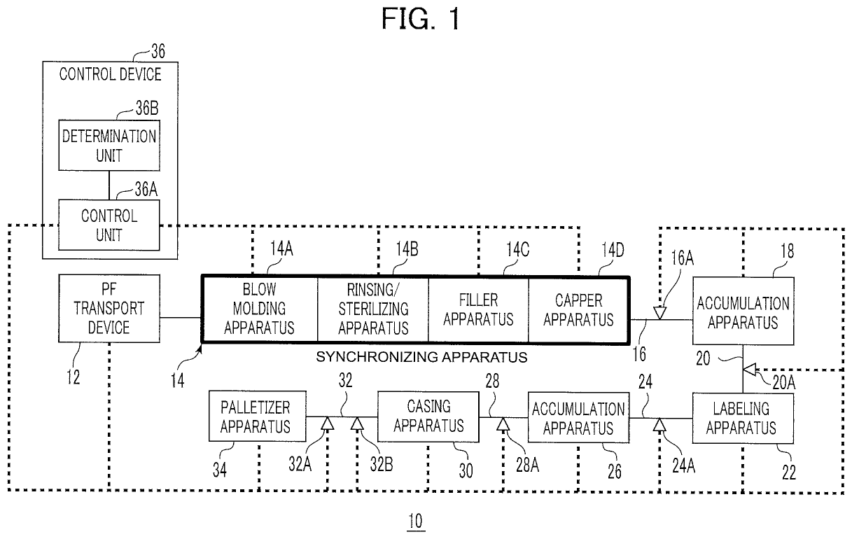

Hereinafter, embodiments of the present invention will be described with reference to the drawings. FIG. 1 is a schematic plan view showing an arrangement of a production system to which a production management system according to one embodiment of the present invention is applied.

The production system 10 according to the present embodiment is a system that performs filling and capping on containers (articles), such as PET bottles, and discharges the containers after packing them into boxes via a palletizer. In the production system 10, preforms (PF) for PET bottles or the like, are supplied to a synchronizing apparatus 14 via a PF transport device 12. The synchronizing apparatus 14 includes, from an upstream side, for example, a blow molding apparatus 14A, a rinsing/sterilizing apparatus 14B, a filler apparatus 14C, and a capper apparatus 14D, and these apparatuses are operated in synchronization.

Containers that have been filled and capped in the synchronizing apparatus 14 are conveyed to a labeling apparatus 22 via a first transport device 16, a first accumulation apparatus 18, and a second transport device 20, and are labeled. Containers discharged from the labeling apparatus 22 are conveyed to a casing apparatus 30 via a third transport device 24, a second accumulation apparatus 26, and a fourth transport device 28, and are packed in boxes in predetermined quantities. Containers packed in boxes in the casing apparatus 30 are conveyed to a palletizer apparatus 34 via a fifth transport device 32, are stacked on pallets, and are discharged.

The first to fifth transport devices 16, 20, 24, 28, and 32 are, for example, conveyors that convey containers in single row, and are provided, at downstream portions (near outlets), with first to fifth sensors 16A, 20A, 24A, 28A, and 32A, respectively. Further, the fifth transport device 32 is provided with a sixth sensor 32B on an upstream side of the fifth sensor 32A.

The first to sixth sensors 16A, 20A, 24A, 28A, 32A, and 32B each detect containers conveyed on a conveyor and transmit the signals to a control device 36. The control device 36 includes a control unit 36A that manages operation of the production system 10 based on signals from the plurality of production apparatuses and the sensors, and a determination unit 36B that determines the cause of the stoppage of a target apparatus.

The control unit 36A monitors the conveyance state of containers on each of the conveyors of the first to fifth transport devices 16, 20, 24, 28, and 32 based on sensor signals from the above-described sensors. That is, based on signals from the first to fifth sensors 16A, 20A, 24A, 28A, and 32A, the control unit 36A determines whether containers are stagnating on the respective transport devices. Specifically, it determines whether the conveyance state of containers is a “container discharge state” in which containers can be discharged downstream, or a “container discharge standby state” in which containers stagnate on the transport device and cannot be discharged downstream. Further, based on a signal from the sixth sensor 32B, the control unit 36A determines a “container shortage state” in which containers are not supplied from upstream onto the fifth transport device 32. It should be noted that sensors that detect the “container shortage state” may be provided in all transport devices, or may be provided only in some of the transport devices.

When it is determined from sensor signals that a transport device is in the “container discharge standby state,” the control unit 36A stops the transport device and stops supply of containers from an upstream production apparatus to the transport device. At this time, when the upstream production apparatus is an accumulation apparatus, the accumulation apparatus accumulates containers, and when the upstream production apparatus is not an accumulation apparatus, the production apparatus is stopped. Further, when it is determined from sensor signals that a “container shortage state” exists, the control unit 36A stops the transport device and stops a downstream production apparatus of the transport device. That is, signals from the first to sixth sensors 16A, 20A, 24A, 28A, 32A, and 32B function as interlock signals.

Error information (alarms) generated in each of the PF transport device 12, the blow molding apparatus 14A, the rinsing/sterilizing apparatus 14B, the filler apparatus 14C, the capper apparatus 14D, the first and second accumulation apparatuses 18 and 26, the labeling apparatus 22, the casing apparatus 30, the palletizer apparatus 34, and the first to fifth transport devices 16, 20, 24, 28, and 32 is transmitted to the control unit 36A. The error information transmitted to the control unit 36A is stored in a storage unit included in the determination unit 36B, which will be described later.

The production management system of the present embodiment is a control system that manages operation of the entire production system 10 by using the control device 36. A user sets a target apparatus in advance from among a plurality of production apparatuses in the production system 10, such as a production apparatus to be used as a central apparatus in system management. As the target apparatus, for example, a bottleneck apparatus having the lowest processing capacity in the production system 10 may be selected. In the present embodiment, an apparatus having the lowest processing capacity is the filler apparatus 14C, and therefore an entire synchronizing apparatus 14 synchronized with the filler apparatus 14C is selected as the target apparatus.

In the production management system of the present embodiment, the control unit 36A also monitors operation of each apparatus in the production system 10. When it is detected, for example, that a number of containers supplied per unit time, detected by a sensor (not shown) provided at an inlet of the target apparatus, becomes zero (that is, no container is supplied for a predetermined time), the determination unit 36B determines that the target apparatus (the synchronizing apparatus 14) has stopped. Then, it identifies an apparatus that has caused a root cause of stopping the target apparatus, and identifies which error in the identified apparatus is the root cause of the stoppage of the target apparatus.

During operation of the production system 10, as described above, the control unit 36A monitors the container conveyance state in the first to fifth transport devices 16, 20, 24, 28, and 32 based on signals from the first to sixth sensors 16A, 20A, 24A, 28A, 32A, and 32B. Further, from each of the first to fifth transport devices 16, 20, 24, 28, and 32, and the respective production apparatuses 12, 14 (14A to 14D), 18, 22, 26, 30, and 34, signals such as error information (alarms) , standby information, production information, and reject information are repeatedly input to the control device 36 periodically or upon occurrence of specific events. These signals are then stored, via the control unit 36A, in the storage unit of the determination unit 36B.

Further, as described above, when the control unit 36A detects a transport device to be in a “container discharge standby state” based on signals from the first to fifth sensors 16A, 20A, 24A, 28A, and 32A, it stops the transport device and stops supply of containers from an upstream production apparatus to the transport device (corresponding to interlock off). Further, the determination unit 36B collects timing information, such as a time and an order in which the transport devices and production apparatuses are stopped, and stores the timing information in the storage unit of the determination unit 36B in association with each apparatus and device.

Upon detecting that supply (conveyance) of containers to the target apparatus is zero for a predetermined period of time and determining that the target apparatus has stopped, the production management system determines, based on error information (alarms) and standby information of the target apparatus, whether a root cause of the stoppage of the target apparatus exists <Case A>60 on a downstream side of the target apparatus, <Case B> on an upstream side of the target apparatus, or <Case C> in the target apparatus itself.

For example, when a direct cause of the stoppage of the target apparatus is attributable to stoppage of discharge of containers from the target apparatus, the production management system determines that a root cause exists in an apparatus on a downstream side of the target apparatus <Case A>. Further, when a direct cause of the stoppage of the target apparatus is attributable to a shortage of containers supplied to the target apparatus, the production management system determines that a root cause exists in an apparatus on an upstream side of the target apparatus <Case B>. Further, when a specific error occurs in the target apparatus, the target apparatus is immediately stopped, and the production management system determines that a root cause exists in the target apparatus itself <Case C>.

In <Case A>, the production management system reads out timing information (such as a time and an order) related to transport devices on the downstream side of the target apparatus from the storage unit included in the determination unit 36B. Then, it identifies a transport device that first stopped among the transport devices that are currently stopped (at a point in time when the target apparatus has stopped). At this time, the root cause of the stoppage of the target apparatus is considered to exist in the identified transport device or in a production apparatus located immediately downstream of the identified transport device.

Accordingly, the determination unit 36B first checks error information (alarms) of the identified transport device stored in the storage unit. When a stoppage cause is present in the error information (alarms), it determines that the root cause exists in the transport device, and identifies the error information (alarms) as the root cause of the stoppage of the target apparatus.

On the other hand, when no stoppage cause is found in the error information (alarms) of the identified transport device, the determination unit 36B determines that the root cause exists in a production apparatus located immediately downstream of the transport device. Then, it reads out error information (alarms) of the production apparatus from the storage unit and identifies error information (alarms) that has caused the production apparatus to stop as a root cause of the stoppage of the target apparatus.

In <Case B>, since only the PF transport device 12 is located on the upstream side of the synchronizing apparatus 14 serving as the target apparatus in the production system 10 of the present embodiment, the determination unit 36B identifies the PF transport device 12 as a device having the root cause. Then, it identifies the root cause that has caused the stoppage of the target apparatus from error information (alarms) of the PF transport device 12 stored in the storage unit.

When a subject production system includes a plurality production apparatuses and transport devices that connect the plurality of production apparatuses on an upstream side of a target apparatus, a cause apparatus or device and a root cause thereof are identified using a procedure similar to that of <Case A>. That is, the production management system reads out timing information (such as a time and an order) related to upstream transport devices relative to the target apparatus from the storage unit. Then, it identifies a transport device that first stopped among the upstream transport devices that are currently stopped (at a point in time when the target apparatus has stopped). At this time, a root cause of the stoppage of the target apparatus is considered to exist in the identified transport device or in a production apparatus located immediately downstream thereof.

The determination unit 36B first checks error information (alarms) of the identified transport device stored in the storage unit. When a stoppage cause is found in the error information (alarms), it determines that a root cause exists in the transport device, and identifies the error information (alarms) as the root cause of the stoppage of the target apparatus.

On the other hand, when no stoppage cause is found in the error information (alarms) of the identified transport device, the determination unit 36B determines that a root cause exists in a production apparatus located immediately downstream of the transport device. Then, it reads out error information (alarms) of the production apparatus from the storage unit and identifies error information (alarms) that has caused the production apparatus to stop as a root cause of the stoppage of the target apparatus.

In <Case C>, the production management system immediately identifies that a root cause exists in the target apparatus itself. Then, it identifies a cause of the stoppage of the target apparatus from error information (alarms) of the target apparatus, and determines the identified cause as the root cause of the stoppage of the target apparatus.

In the present embodiment, the target apparatus is the synchronizing apparatus 14 including the blow molding apparatus 14A, the rinsing/sterilizing apparatus 14B, the filler apparatus 14C, and the capper apparatus 14D. Therefore, the determination unit 36B checks respective error information (alarms) of the blow molding apparatus 14A, the rinsing/sterilizing apparatus 14B, the filler apparatus 14C, and the capper apparatus 14D, and identifies an apparatus that has caused a root cause and the cause thereof.

Next, specific processing flows in <Case A>, <Case B>, and <Case C> in the production management system will be described with reference to specific examples.

### (1) SPECIFIC EXAMPLE OF <CASE A>

### (1.1) Flow Until the Stoppage of the Target Apparatus in <Case A>

First, a flow from occurrence of a problem in an apparatus on a downstream side of the target apparatus to the stoppage of the synchronizing apparatus 14 serving as the target apparatus will be described with reference to a specific example. Here, a case will be described in which, for example, a “sheet entanglement occurrence (alarm)” occurs in the casing apparatus 30 and the target apparatus stops.

When sheet entanglement occurs in the casing apparatus 30 and the casing apparatus 30 stops, supply of containers to the casing apparatus 30 is stopped. Then, based on a signal from the fourth sensor 28A, a conveyance state of the “fourth transport device 28” becomes a “container discharge standby state.”

When the fourth transport device 28 is in the “container discharge standby state,” the fourth transport device 28 is stopped. Substantially simultaneously, discharge of containers from the second accumulation apparatus 26 to the fourth transport device 28 is stopped, and containers supplied from the third transport device 24 are accumulated in the second accumulation apparatus 26. Since the casing apparatus 30 is stopped and containers are no longer supplied from the casing apparatus 30 to the fifth transport device 32, a “container shortage state” is detected by the sixth sensor 32B when a predetermined period of time has elapsed, and the fifth transport device 32 is stopped. Further, since containers (cases containing containers) are no longer supplied from the fifth transport device 32, the palletizer apparatus 34 is stopped.

When the “container discharge standby state” of the fourth transport device 28 continues and the second accumulation apparatus 26 becomes full, a conveyance state of the third transport device 24 becomes the “container discharge standby state” based on a signal from the third sensor 24A. As a result, the third transport device 24 is stopped, and discharge of containers from the labeling apparatus 22 to the third transport device 24 is stopped. Further, substantially simultaneously, operation of the labeling apparatus 22 itself is also stopped.

As a result, the conveyance state of the second transport device 20 becomes the “container discharge standby state.” This state is detected by the second sensor 20A, and the second transport device 20 is stopped. Substantially simultaneously, discharge of containers from the first accumulation apparatus 18 to the second transport device 20 is stopped, and containers supplied from the first transport device 16 are accumulated in the first accumulation apparatus 18. When the “container discharge standby state” of the second transport device 20 continues and the first accumulation apparatus 18 becomes full, the conveyance state of the first transport device 16 becomes the “container discharge standby state” based on a signal from the first sensor 16A. As a result, the first transport device 16 is stopped, and both discharge of containers from the synchronizing apparatus 14 serving as the target apparatus to the first transport device 16 and operations of the respective apparatuses 14A to 14D of the synchronizing apparatus 14 and the PF transport device 12 are stopped.

### (1.2) Cause Identification Processing in <Case A>

In the above-described specific example (stoppage of the casing apparatus 30), when the synchronizing apparatus 14 serving as the target apparatus is stopped and it is detected that no supply (conveyance) of containers has been made for a predetermined period of time at an inlet of the target apparatus, the control device 36 detects the stoppage of the target apparatus and determines whether a direct cause of the stoppage of the target apparatus is attributable to stoppage of discharge of containers from the target apparatus. In the above <Case A>, since the direct cause of the stoppage of the target apparatus is stoppage of discharge of containers, the determination unit 36B determines that abnormal stoppage of the target apparatus corresponds to <Case A>.

As described above, when it is determined that the situation corresponds to <Case A>, the determination unit 36B identifies a transport device that first stopped among transport devices on the downstream side that are stopped at a point in time when the target apparatus has stopped.

In this case, since the fourth transport device 28 is the transport device that first stopped, the fourth transport device 28 is identified as the transport device that first stopped.

Next, whether a stoppage cause exists in the fourth transport device 28 itself is investigated on the basis of error information (alarms) of the fourth transport device 28. In this specific example, since no stoppage cause exists in the fourth transport device 28 itself, the determination unit 36B identifies that a cause exists in the casing apparatus 30, which is a production apparatus located immediately downstream thereof. Then, it checks error information (alarms) of the casing apparatus 30. As a result, “sheet entanglement of a packaging sheet” in the casing apparatus 30 is identified as a root cause of the stoppage of the target apparatus.

### (2) SPECIFIC EXAMPLE OF <CASE B>

### (2.1) Flow Until the Stoppage of the Target Apparatus in <Case B>

Here, a flow in a case where, for example, “clogging of PF conveyance” occurs in the PF transport device 12 located on an upstream side of the target apparatus and the synchronizing apparatus 14 is stopped will be described. When “clogging of PF conveyance” occurs, supply of containers to the synchronizing apparatus 14 serving as the target apparatus is stopped. As a result, the synchronizing apparatus 14 is stopped due to a shortage of preforms supplied to the target apparatus. At this time, the PF transport device 12 outputs a signal indicating “occurrence of clogging of PF conveyance” as error information (an alarm), and transmits the signal to the control device 36. Then, the information is stored in the storage unit of the determination unit 36B via the control unit 36A.

### (2.2) Cause Identification Processing in <Case B>

In <Case B>, when the synchronizing apparatus 14 serving as the target apparatus is stopped, the determination unit 36B identifies that the root cause of the stoppage of the target apparatus exists in the PF transport device 12 on the basis that the cause is a shortage of containers. Thereafter, it checks error information (alarms) of the PF transport device 12 stored in the storage unit, and identifies “clogging of PF conveyance” as the root cause of the stoppage of the target apparatus.

### (3) SPECIFIC EXAMPLE OF <CASE C>

### (3.1) Flow Until the Stoppage of the Target Apparatus in <Case C>

For example, a flow in a case where the synchronizing apparatus 14 is stopped due to “shortage of caps” in the capper apparatus 14D will be described. When “shortage of caps” occurs in the capper apparatus 14D, the synchronizing apparatus 14 serving as the target apparatus is immediately stopped. At this time, the capper apparatus 14D outputs a signal indicating “shortage of caps” as error information (an alarm), and transmits the signal to the determination unit 36B via the control unit 36A. Then, the information is stored in the storage unit of the determination unit 36B.

### (3.2) Cause Identification Processing in <Case C>

In Case C, when the production management system detects the stoppage of the synchronizing apparatus 14 serving as the target apparatus, it determines that a direct cause thereof does not correspond to <Case A> or <Case B>. At this time, the determination unit 36B determines that a root cause of the stoppage of the target apparatus exists in the target apparatus itself. Then, it inspects error information (alarms) generated in each apparatus included in the synchronizing apparatus 14, and identifies “shortage of caps” in the capper apparatus 14D as the root cause based thereon. Further, when specific error information (alarms) is transmitted to the determination unit 36B, it may immediately identify such error information as the root cause that has caused the stoppage of the synchronizing apparatus 14.

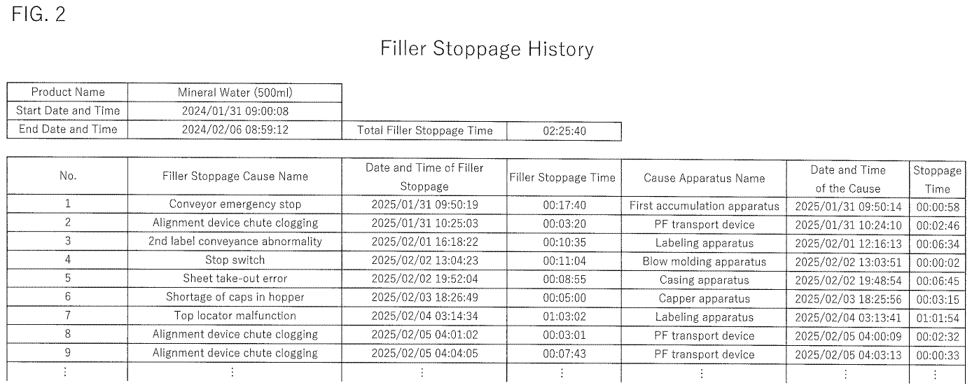

Each time the target apparatus stops, the production management system of the present embodiment stores a result identified by the cause identification processing as a history. FIG. 2 shows an example of a history of apparatuses identified as a root cause and corresponding causes when the filler apparatus 14C serving as the target apparatus is stopped. As shown in FIG. 2, in the production management system of the present embodiment, both a “cause apparatus name” and a “filler stoppage cause name,” as well as a “filler stoppage time,” are recorded as the history. Further, as additional information, a “date and time of filler stoppage,” a “date and time of the cause” in the cause apparatus, and a “stoppage time” thereof are recorded.

As described above, according to the production management system of the present embodiment, in a production system in which articles (containers) are sequentially processed by a plurality of production apparatuses via a plurality of transport devices, it is possible to efficiently identify an area or an apparatus that has caused the stoppage of a target apparatus with a simplified configuration. Further, by identifying a root cause that has caused the stoppage of the target apparatus, it is possible to grasp a portion to be preferentially improved, thereby improving an operation rate of the production system.

Further, according to the production management system of the present embodiment, it is possible to detect an apparatus that has caused the stoppage of a target apparatus and a root cause thereof by using interlock signals of transport devices. Since such interlock signals are commonly used in line control of production lines, they are highly reliable and can be readily applied to an existing production line.

In the present embodiment, the synchronizing apparatus includes up to the capper apparatus; however, the synchronizing apparatus may include up to the labeling apparatus. Further, an arrangement of accumulation apparatuses is not limited to that of the present embodiment. An accumulation apparatus may also be provided between the casing apparatus and the palletizer apparatus, or an accumulation apparatus may be provided only between the synchronizing apparatus and the labeling apparatus (or another apparatus downstream of the synchronizing apparatus).

### DESCRIPTION OF REFERENCE SIGNS

10: production system
12: PF transport device
14: synchronizing apparatus (target apparatus)
16, 20, 24, 28, 32: first to fifth transport devices
16A, 20A, 24A, 28A, 32A: first to fifth sensors
18, 26: accumulation apparatuses (production apparatuses)
22: labeling apparatus (production apparatus)
30: casing apparatus (production apparatus)
34: palletizer apparatus (production apparatus)
36: control device
36A: control unit
36B: determination unit

1. A production management system for a production system comprising a plurality of production apparatuses and transport devices sequentially connecting the plurality of production apparatuses, wherein each of the transport devices is provided with a sensor configured to detect a standby state for discharging articles to a downstream production apparatus, the production management system comprising:
control unit configured to manage operation of the production system based on signals from the plurality of production apparatuses and the sensors; and
a determination unit configured to determine a cause of the stoppage of a target apparatus selected in advance from among the plurality of production apparatuses;
wherein the control unit is configured to stop the transport device provided with the sensor and to stop discharge of the articles from an upstream production apparatus to the transport device when the sensor detects the standby state; and
wherein the determination unit is configured to identify a transport device that first stopped on a downstream side of the target apparatus when the target apparatus stops due to stoppage of discharge of the articles from the target apparatus.

2. The production management system according to claim 1, wherein the determination unit is configured to determine the cause of the stoppage of the target apparatus based on error information output from the identified transport device or a production apparatus located downstream thereof.

3. The production management system according to claim 1, wherein the determination unit is configured to determine that the cause of the stoppage of the target apparatus exists in an apparatus located upstream of the target apparatus when the target apparatus stops due to a shortage of the articles supplied to the target apparatus.
